(19) United States
(12) Patent Application Publication
(10) Pub. No.: US 2025/0170823 A1
(43) Pub. Date: May 29, 2025

(54) LIQUID EJECTION DRIVE DEVICE

(71) Applicant: RISO Technologies Corporation, Tokyo (JP)

(72) Inventor: Masaya ICHIKAWA, Tagata Shizuoka (JP)

(21) Appl. No.: 18/783,135

(22) Filed: Jul. 24, 2024

(30) Foreign Application Priority Data
Nov. 27, 2023 (JP) 2023-199707

(51) Int. Cl. B41J 2/045

(52) U.S. Cl. CPC B41J 2/04588; B41J 2/04581; B41J 2/0459; B41J 2/04591

(57) ABSTRACT

According to one embodiment, a liquid ejection drive device includes a drive circuit configured to apply a drive signal to an actuator for driving an ejection of a liquid from a pressure chamber connected to a nozzle. The drive signal includes a multidrop waveform with a plurality of drop waveforms each for causing one droplet to be ejected. Each drop waveform has an expansion phase, a normal phase, and a contraction phase. At least one drop waveform in the plurality of drop waveforms is an adjustment drop waveform having an auxiliary contraction phase in which contraction of the pressure chamber is less than in the (full) contraction phase. This auxiliary contraction phase is after the expansion phase but before the (full) contraction phase.

### CROSS-REFERENCE TO RELATED APPLICATION

This application is based upon and claims the benefit of priority from Japanese Patent Application No. 2023-199707, filed Nov. 27, 2023, the entire contents of which are incorporated herein by reference.

### FIELD

Embodiments described herein relate generally to a drive device for liquid ejection devices.

### BACKGROUND

A multidrop drive technique is known as one type of ejection control for liquid ejection devices such as inkjet heads. With multidrop drive, there is a need to reduce the difference in ejection speeds of drops so as to enhance printing performance. There is a method of increasing the ejection speed by adding a micro-vibration pulse before an ejection waveform. However, typically, while the first drop is greatly affected by the addition of a micro-vibration pulse before ejection, adjustment of the ejection speed for the next drops after the first becomes challenging.

### BRIEF DESCRIPTION OF THE DRAWINGS

FIG. 1 depicts a liquid ejection device according to a first embodiment.

FIG. 2 is a perspective view of a liquid ejection head according to a first embodiment.

FIG. 3 is a waveform diagram illustrating a multidrop waveform according to a first embodiment.

FIG. 4 is a waveform diagram illustrating ejection waveforms for a plurality of drops according to a first embodiment.

FIG. 5 is a waveform diagram illustrating a standard drop waveform.

FIG. 6 is a waveform diagram illustrating an adjustment drop waveform.

FIG. 7 is a graph of measured ejection speeds of drops generated by a multidrop waveform.

FIG. 8 is a graph illustrating measured ejection speeds of drops generated by a multidrop waveform.

FIG. 9 is a graph illustrating pulse widths for drops in a multidrop waveform.

FIG. 10 is a graph illustrating ejection speed for a full drive of a multidrop waveform.

FIG. 11 is a waveform diagram illustrating a multidrop waveform according to a second embodiment.

FIG. 12 is a waveform diagram illustrating ejection waveforms for a plurality of drops according to a second embodiment.

FIG. 13 is a graph illustrating measured ejection speeds of drops generated by a multidrop waveform according to a second embodiment.

FIG. 14 is a graph illustrating measured ejection speeds of drops generated by a multidrop waveform according to a second embodiment.

FIG. 15 is a graph illustrating measured ejection speeds of drops generated by a multidrop waveform according to a second embodiment.

FIG. 16 is a graph illustrating measured ejection speeds of drops generated by a multidrop waveform according to a second embodiment.

FIG. 17 is a graph illustrating measured ejection speeds of drops generated by a multidrop waveform according to a second embodiment.

FIG. 18 is a graph illustrating pulse widths for drops in a multidrop waveform according to a second embodiment.

FIG. 19 is a graph illustrating ejection speeds for a full drive of a multidrop waveform according to a second embodiment.

FIG. 20 is a waveform diagram illustrating a multidrop waveform according to a third embodiment.

FIG. 21 is a waveform diagram illustrating ejection waveforms for a plurality of drops according to a third embodiment.

FIG. 22 is a waveform diagram illustrating a multidrop waveform according to a comparative example.

FIG. 23 is a graph illustrating measured ejection speeds of drops generated by a multidrop waveform according to the comparative example.

### DETAILED DESCRIPTION

A drive device that can reduce the difference in ejection speeds between drops is described.

According to one embodiment, a liquid ejection drive device includes a drive circuit configured to apply a drive signal to an actuator for driving an ejection of a liquid from a pressure chamber connected to a nozzle. The drive signal includes a multidrop waveform with a plurality of drop waveforms for causing one droplet to be ejected. Each drop waveform has an expansion phase, a normal phase, and a contraction phase. At least one drop waveform in the plurality of drop waveforms is an adjustment drop waveform having an auxiliary contraction phase in which contraction of the pressure chamber is less than in the contraction phase. This auxiliary contraction phase is after the expansion phase but before the contraction phase.

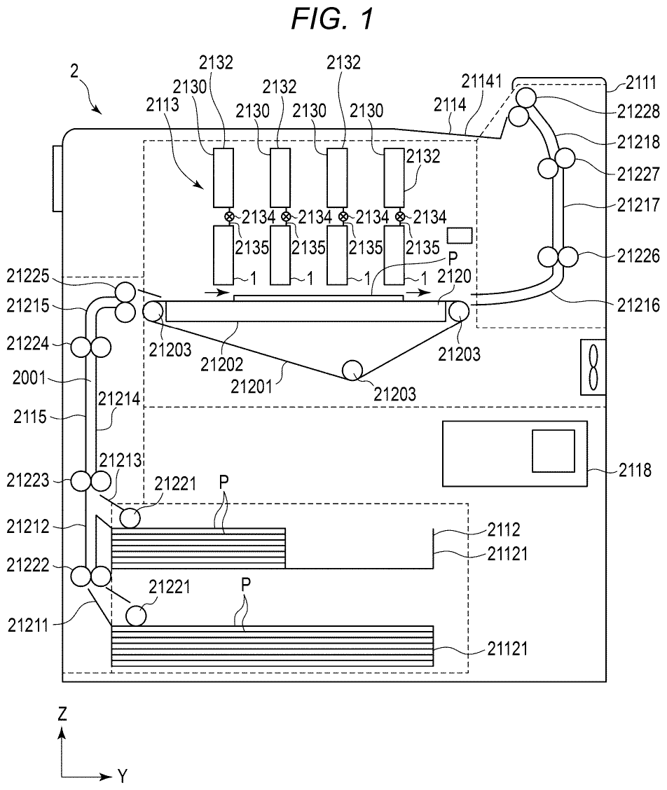

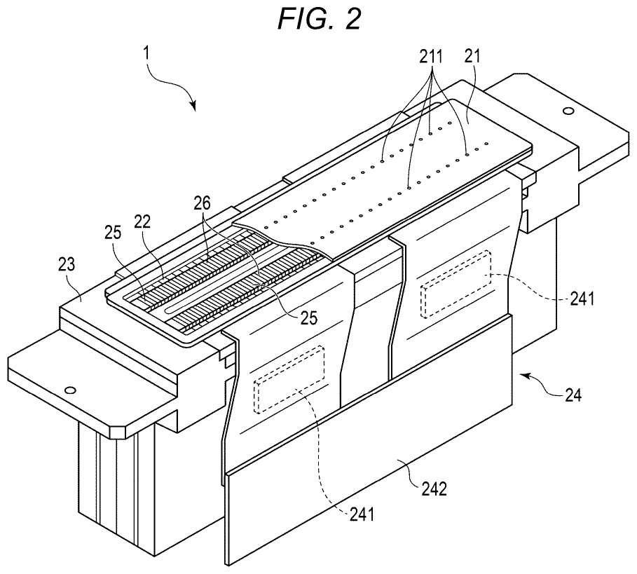

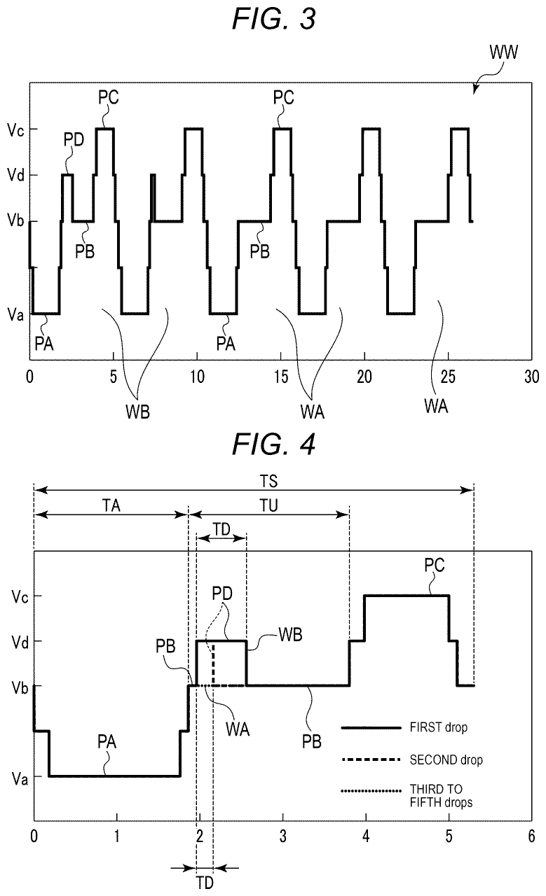

Hereinafter, a first embodiment of a liquid ejection head 1 and a liquid ejection device 2 using the liquid ejection head 1 will be described with reference to FIGS. 1 to 3. FIG. 1 is an explanatory diagram illustrating a configuration of the liquid ejection device 2 according to the first embodiment, and FIG. 2 is a perspective view illustrating the configuration of the liquid ejection head 1. FIG. 3 is a waveform diagram illustrating a multidrop waveform according to the first embodiment, and FIG. 4 is a waveform diagram illustrating ejection waveforms for a plurality of drops. In the drawings, the aspects may be enlarged, reduced, or omitted as appropriate for the sake of clarity in the description.

The liquid ejection device 2 including liquid ejection heads 1 will be described with reference to FIG. 1. The liquid ejection device 2 includes a housing 2111, a medium supply portion 2112, an image formation portion 2113, a medium discharge portion 2114, a conveyance device 2115, and a control portion 2118.

The liquid ejection device 2 is an inkjet printer that performs image formation on paper P by ejecting liquid ink while conveying paper P (a recording medium or an ejection target), along a predetermined conveyance path 2001 from the medium supply portion 2112 through the image formation portion 2113 to the medium discharge portion 2114.

The medium supply portion 2112 includes a plurality of paper feed cassettes 21121. The image formation portion 2113 includes a support portion 2120 that supports paper, and a plurality of head units 2130 that are arranged above the support portion 2120. The medium discharge portion 2114 includes a paper discharge tray 21141.

The support portion 2120 includes a conveyor belt 21201 provided in a loop shape, a support plate 21202 that supports the conveyor belt 21201 from a back side, and a plurality of belt rollers 21203 provided on a back side of the conveyor belt 21201.

The head unit 2130 includes a plurality of liquid ejection heads 1 (that are inkjet heads in this example), a plurality of supply tanks 2132 (liquid tanks) mounted on the liquid ejection heads 1, pumps 2134 that supply ink, and connection flow paths 2135 that respectively connect the supply tanks 2132 to the liquid ejection heads 1.

The liquid ejection head 1 is supplied with ink stored in the supply tank 2132. The liquid ejection heads 1 may each be a non-circulating head type that does not circulate ink therethrough or may be a circulating head that permits ink to circulate therethrough.

In the present example, the liquid ejection heads 1 include the liquid ejection heads 1 for four colors (cyan, magenta, yellow, and black) and the supply tanks 2132 for these four colors. The supply tanks 2132 are respectively connected to the liquid ejection heads 1 by a connection flow path 2135.

As illustrated in FIG. 2, the liquid ejection head 1 includes a nozzle plate 21 with a plurality of nozzles 211, an actuator board 22, a manifold 23 bonded to the actuator board 22, and a drive circuit 24 (also referred to as a drive portion).

The actuator board 22 includes an actuator 25 (liquid ejection portion) including a plurality of pressure chambers 26 (that are arranged to face the nozzles 211 and communicate with the nozzles 211) and a drive element portion adjacent to the plurality of pressure chambers 26. The actuator board 22 is configured to have a shape that forms or provides a flow path in conjunction with the nozzle plate 21. This flow path passes through the plurality of pressure chambers 26

An electrode connected to the drive circuit 24 is formed in the drive element portion of the actuator 25 adjacent to the pressure chamber 26. The electrode is connected to the control portion 2118 through a driver (driver element) of the drive circuit 24 by a wire and is configured to be selectively drive-controllable under control by a processor.

The drive circuit 24 includes one or more driver ICs 241 and a wiring board 242. The drive circuit 24 drives the actuator 25 by applying a drive voltage to a wiring pattern connected to the actuator 25 by using the driver IC 241. The applied voltage to the actuator increases or decreases a volume of a pressure chamber 26 to cause a droplet to be ejected from the nozzles 211 opposite the respective pressure chamber 26.

The pressure chamber 26 is on a flow path through the liquid ejection head 1 formed by the nozzle plate 21, the actuator board 22, and the manifold 23. The flow path is connected to the connection flow path 2135 of the liquid ejection device 2. For example, the liquid ejection head 1 is an inkjet head of a shear-mode type.

The pump 2134 is a liquid conveyance pump such as a piezoelectric pump. The pump 2134 is connected to the control portion 2118 and is driven and controlled by the control portion 2118.

The connection flow path 2135 includes a supply flow path connected to an ink supply pipe of the liquid ejection head 1. Also, the connection flow path 2135 includes a recovery flow path connected to an ink discharge pipe of the liquid ejection head 1. For example, when the liquid ejection head 1 is a non-circulating type, the recovery flow path is connected to a maintenance device, and when the liquid ejection head 1 is a circulating type, the recovery flow path is connected to the supply tank 2132.

The conveyance device 2115 conveys the paper P along the conveyance path 2001 from a paper feed cassette 21121 through the image formation portion 2113 to a paper discharge tray 21141. The conveyance device 2115 includes a plurality of guide plate pairs (guide plate pairs 21211, 21212, 21213, 21214, 21215, 21216, 21217, 21218) arranged along the conveyance path 2001 and a plurality of conveyance rollers (conveyance rollers 21221, 21222, 21223, 21224, 21225, 21226, 21227, 21228). The conveyance device 2115 supports the paper P and permits the paper P to be moved relative to the liquid ejection head 1.

The control portion 2118 is, for example, a control board, controller board, or the like. The control portion 2118 includes a processor, a read only memory (ROM), a random access memory (RAM), an I/O port (input and output port), and an image memory.

The processor is a processing circuit such as a central processing unit (CPU). The processor controls, through signals via the I/O port, the head unit 2130, a drive motor, an input operation portion, various sensors, and the like provided in the liquid ejection device 2. The processor causes print data stored in the image memory to the drive circuit 24 to be transmitted in a drawing (printing) order.

Also, the control portion 2118 determines (e.g., calculates or selects) an adjustment drop waveform based on adjustment data. For example, the adjustment drop waveform to be applied can be selected from adjustment drop waveforms that can be set in multiple steps, stages, or increments.

The ROM stores various programs and the like. The RAM temporarily stores various types of variable data, image data, and the like. The I/O port is an interface portion that receives data from the outside and outputs data to the outside. The print data from an externally connected device may be transmitted to the control portion 2118 through the I/O port and stored in the image memory.

The print data is data input (sent) to a head that has been converted from image data or the like. The image data can include information about color and image density for each region to be printed. The print data is used to cause liquid (ink) to be ejected in a manner corresponding to the image data. The liquid ejection head 1 selects a drive waveform based on the print data and applies the drive waveform to the actuator 25.

Hereinafter, characteristics of the liquid ejection head 1 used in the liquid ejection device 2 according to an embodiment and a drive waveform of a drive signal generated by the drive circuit 24 will be described. For example, the liquid ejection head 1 is multidrop-driven and can be driven at multiple gradations (grayscale values) by combining a plurality of drop waveforms including a standard drop waveform and an adjustment drop waveform. That is, the drive circuit 24 is driven with drive waveforms for multi-gradation by multidrop signals for multiple patterns (multiple types).

The control portion 2118 sets a drive waveform to be applied to each drive element based on the print data. For example, the control portion 2118 sets a combination of an adjustment drop waveform and a standard drop waveform based on the print data. As a specific example, the control portion 2118 selects a drive pattern from a plurality of preset and stored patterns. Also, the control portion 2118 sets an adjustment amount for an adjustment drop waveform for each nozzle.

For example, the control portion 2118 drives each of the drive elements (each corresponding to a nozzle) with a plurality of multi-waveform patterns including a standard drop waveform, an adjustment drop waveform, and a non-ejection waveform set based on the print data.

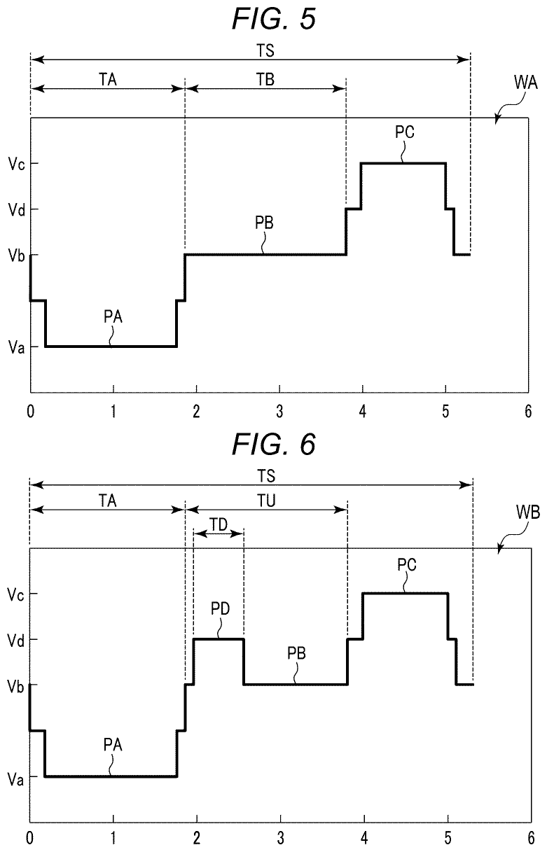

FIG. 3 is a graph illustrating an example of a drive waveform. The present example has a drive waveform having five drop waveforms (elements) during a single print cycle. FIG. 4 is a drive waveform illustrating an ejection waveform for each drop. FIG. 5 illustrates a standard drop waveform, and FIG. 6 illustrates an adjustment drop waveform. In FIGS. 3 to 6, vertical axes represent a voltage (V), and horizontal axes represent time (μs).

For example, a multidrop waveform WW has a plurality of drop waveforms (droplet waveforms). The multidrop waveform WW is composed of a combination of standard drop waveforms WA and adjustment drop waveforms WB.

In the multidrop waveform WW according to the first embodiment, the first and second drops are both adjustment drop waveforms WB, and the third to fifth drops are standard drop waveforms WA.

Here, as illustrated in FIG. 5, the standard drop waveform WA has pulse waveforms including an expansion element PA (expansion phase), a normal element PB (normal phase), and a contraction element PC (contraction phase). That is, the standard drop waveform WA causes the pressure chamber 26 to eject one droplet through a cycle of an expansion state (phase), a normal state (phase), and a contraction state (phase).

A pulse width TA of the expansion element PA in the standard drop waveform WA is assumed to be an acoustic length (AL), which is a half of a natural vibration cycle of the pressure chamber 26 of the liquid ejection head 1.

For example, the standard drop waveform WA is a waveform having an ejection volume of 4 pL (picoliters). For example, the maximum ejection amount would be 5 drops and 20 pL.

The adjustment drop waveform WB (see FIG. 6) has an expansion element PA, an normal element PB, an auxiliary contraction element PD, and a contraction element PC. That is, the adjustment drop waveform WB causes the pressure chamber 26 to eject one droplet through a cycle including an expansion state, an auxiliary contraction state, a normal state, and a contraction state. Here, the cycle TS for both the drop waveforms WA and WB is the same.

As illustrated in FIGS. 3 to 6, the standard drop waveform WA includes the expansion element PA for expanding the pressure chamber 26 by decreasing a voltage from an intermediate voltage Vb to an expansion voltage Va and causing ink to be ejected by returning to the intermediate voltage Vb after a certain period of time, the normal element PB for maintaining the intermediate voltage Vb for a certain period of time, and the contraction element PC for contracting the pressure chamber 26 by increasing a voltage from the intermediate voltage Vb to a contraction voltage Vc that is higher than the expansion voltage Va and the intermediate voltage Vb and returning again the voltage to the intermediate voltage Vb. For example, the intermediate voltage Vb=0 V.

For example, the standard drop waveform WA illustrated in FIGS. 3 to 5 uses stepped waveforms by which a voltage gradually changes in stages during expansion and contraction but in other examples the voltage changes may occur directly without intermediate stages.

The adjustment drop waveform WB includes the expansion element PA for expanding the pressure chamber 26 by decreasing the intermediate voltage Vb to the expansion voltage Va and causing ink to be ejected by returning to the intermediate voltage Vb after a certain period of time, the auxiliary contraction element PD for slightly vibrating the pressure chamber 26 by increasing the intermediate voltage Vb to an auxiliary contraction voltage Vd, and returning to the intermediate voltage Vb after a certain period of time, the normal element PB for maintaining the intermediate voltage Vb for a certain period of time, and the contraction element PC for contracting the pressure chamber 26 by increasing a voltage to the contraction voltage Vc and returning again to the intermediate voltage Vb. For example, the intermediate voltage Vb=0 V. Here, a contraction amount associated with the auxiliary contraction element PD is less than a contraction amount associated with the contraction element PC. For example, the auxiliary contraction voltage Vd is less than the contraction voltage Vc such as about half the contraction voltage Vc. The auxiliary contraction element PD in this example starts after the expansion element PA but the voltage may be increased to the auxiliary contraction voltage Vd after the expansion voltage Va is returned to the intermediate voltage Vb and after a certain period of time has elapsed.

The adjustment drop waveform WB has an additional pulse that contracts at about half the contraction element PC immediately after the expansion state ends, at timing of a normal state provided between expansion and contraction of the standard drop waveform WA. In the adjustment drop waveform WB, the pulse width TA of the expansion element PA is assumed to be an acoustic length (AL), which is half the time of a natural vibration cycle of the pressure chamber 26 in the liquid ejection head 1.

For example, the adjustment drop waveform WB illustrated in FIGS. 3 to 6 is a stepped waveform in which a voltage gradually increases and decreases in steps, stages, or increments. In other examples, the change may be without intermediate steps, stages, or increments.

In this example, in the adjustment drop waveform WB, the contraction amount can be adjusted in multiple steps. For example, the control portion 2118 adjusts an ejection volume by adjusting a pulse width and height (amplitude) of each element of the adjustment drop waveform WB in multiple stages. That is, in addition to selecting and setting each element pulse width or height of the adjustment drop waveform WB for each nozzle, the control portion 2118 can adjust an ejection volume of droplets ejected by selecting a pattern of the adjustment drop waveform WB, the standard drop waveform WA, and the non-ejection waveform based on print data.

The control portion 2118 sets a width of the auxiliary contraction element PD (auxiliary contraction pulse) to be small in response to an increase in the number of drops. That is, in the multidrop waveform WW, the later in the sequence order of drops, the smaller the contraction amount in the drop ejection waveform in an auxiliary contraction state. Specifically, a pulse width TD of the auxiliary contraction element PD of the adjustment drop waveform WB of the second drop is less than a pulse width TD of the auxiliary contraction element PD of the adjustment drop waveform WB of the first drop.

Here, the greater the width of the auxiliary contraction element PD, the more the ejection speed increases. Also, when the auxiliary contraction element PD is not inserted, the ejection speed increases with an increase in the number of drops. Accordingly, when an ejection speed of each drop is to be constant, the pulse width can be reduced in response to the increase in the number of drops. Therefore, in order to reduce the difference in ejection speed between drops, the width of a half-contraction pulse can be reduced in response to the increase in the number of drops, and thereby, a speed difference can be reduced.

Therefore, by adjusting the pulse width TD of the auxiliary contraction element PD, the later in the sequence order of drops, the smaller the contraction amount of the auxiliary contraction. In the present embodiment, at least the final drop is a standard drop waveform WA that does not include the auxiliary contraction element PD. Additional drops before the final drop may also be the standard (reference) drop waveform WA.

In the multidrop waveform WW, the time TS for the adjustment drop waveforms WB is constant. Also, the pulse width TA in the expansion state is set to AL. Also, a total TU of the pulse widths in each adjustment drop waveform WB in an auxiliary contraction state and a normal state is substantially fixed (within a certain range). For example, the time in the expansion state and the time in the contraction state are each constant, and a sum total of time in the auxiliary contraction state and the normal state is substantially constant. That is, when the pulse width TD of the auxiliary contraction state is increased, the pulse width of the normal state is correspondingly decreased and conversely, when the pulse width TD of the auxiliary contraction state is decreased, the pulse width of the normal state is correspondingly increased. That is, the overall time does not change.

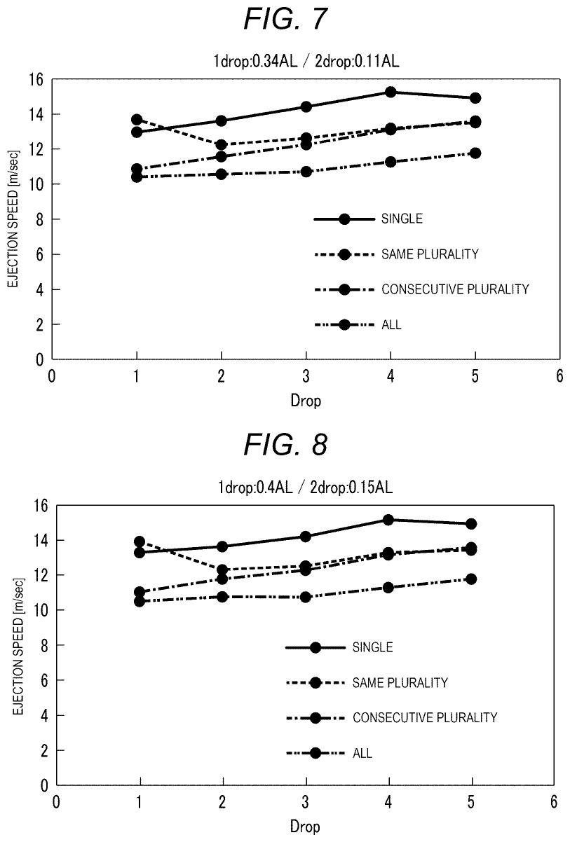

FIGS. 7 and 8 are graphs illustrating measured ejection speed when a plurality of nozzles are driven by the multidrop waveform WW. Horizontal axes indicate a sequence order of the drops (drop number in the multidrop ejection sequence), and vertical axes indicate an ejection speed. Each graph shows ejection speeds for different drive conditions, that is, four types of nozzle drive conditions. For the different drive conditions, a case where just one nozzle is driven and measured (“single”), a case where a plurality of non-consecutive nozzles are driven simultaneously with just one measured (“same plurality”), a case where a plurality of consecutive nozzles are driven with just one measured (“consecutive plurality”), and a case where all available nozzles are driven with just one measured. For each of these different drive conditions, the output of the same nozzle was measured in each case. As illustrated in FIGS. 7 and 8, differences in ejection speed are shown to occur due to changes in drive conditions. Also, since possible combinations for conditions for making the ejection speed of each drop substantially constant are not unique and have a certain margin, a plurality of measurement results under differentrive conditions are shown. FIGS. 7 and 8 illustrate results measured by changing the pulse width TA of an expansion element, that is, the pulse width TD of the auxiliary contraction element PD in response to AL, as the drive condition.

FIG. 7 illustrates a case where the pulse width TD of the auxiliary contraction element PD of the first drop is 0.34 AL and the pulse width TD of the auxiliary contraction element PD of the second drop is 0.11 AL, and FIG. 8 illustrates a case where the pulse width TD of the auxiliary contraction element PD of the first drop is 0.4 AL and the pulse width TD of the auxiliary contraction element PD of the second drop is 0.15 AL.

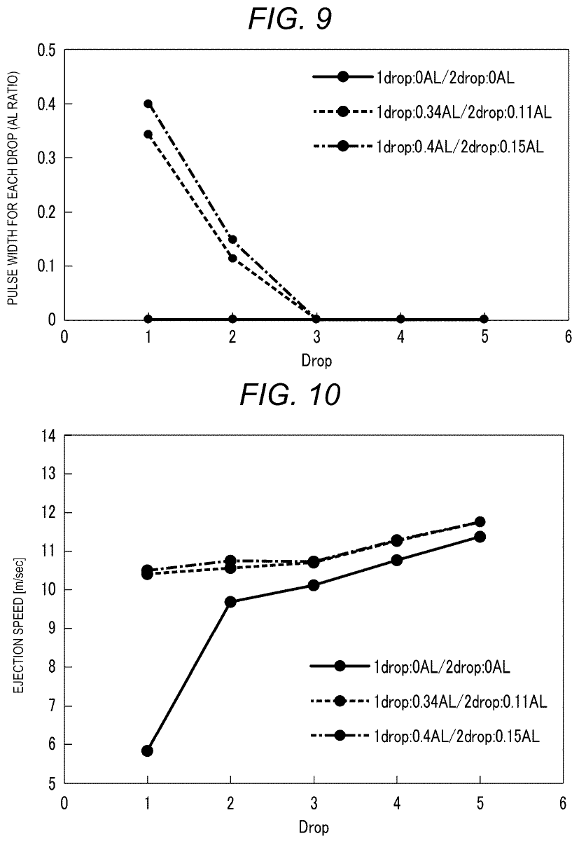

FIG. 9 is a graph illustrating the pulse width TD of the auxiliary contraction element PD. The horizontal axis represents the drop number in the drop sequence, and the vertical axis represents the pulse width TD for each drop. FIG. 10 illustrates a comparison between ejection speeds when all nozzles are driven. As illustrated in FIG. 10, it can be seen that by adjusting the pulse width TD, the difference in ejection speed between drops is reduced.

According to the first embodiment, in a drive waveform for each gradation, the adjustment drop waveforms WB including the auxiliary contraction elements PD are combined with each other after expansion, and the adjustment is conducted such that the later the drop is in the sequence, the smaller the auxiliary contraction element PD is, and thus, a difference in ejection speed can be reduced across the drop sequence.

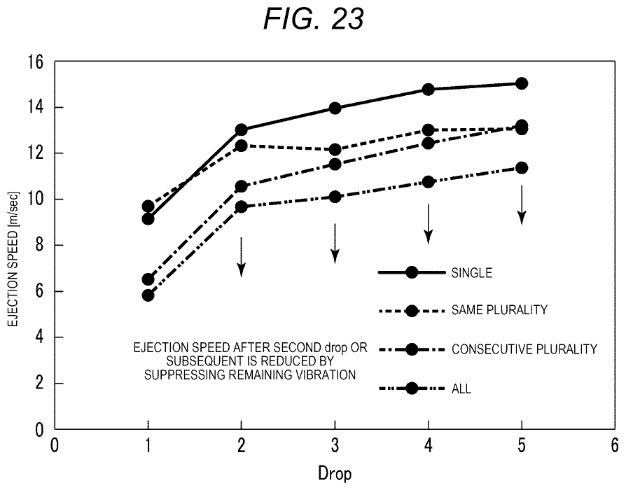

For example, as illustrated in FIG. 22 as a comparative example, when configured with only the standard drop waveform WA, the ejection speed is reduced as the number of drops of a previous number decreases, as illustrated in FIG. 23. Also, as the number of drops increases and the order becomes later, the ejection speed increases and finally saturates at a certain ejection speed. Also, it is possible to consider a technology that increases the ejection speed of droplets immediately after a micro-vibration pulse by inserting a short pulse (micro-vibration pulse) for contracting an actuator before the drive waveform, but droplets that are effective by the micro-vibration pulse are mainly the first drop, and the second drop and subsequent drops have no significant effect. Furthermore, according to a cycle of pressure waves, the ejection speed of the second drop may decrease due to the influence of residual vibration. According to another method, vibration generated by a drive waveform is suppressed by adjusting insertion timing and the pulse width TD of a contraction portion of the drive waveform, and thereby, ejection speed of the second drop and subsequent drops is suppressed, and as a result, a difference in ejection speed between a plurality of drops is suppressed, but when adjusting the drive waveform by using the method, a drive voltage is increased, and power consumption required for ejection per unit volume increases.

In contrast to this, according to the present embodiment, by reducing an auxiliary pulse of a subsequent drop while applying the auxiliary pulse, ejection speed of low drops can increase while suppressing power consumption, and furthermore, a difference in ejection speed between respective drops can be controlled to be extremely small.

Also, by causing one or more drops including at least the final drop to be a standard drop waveform, power consumption can be suppressed.

Although an embodiment is described above, embodiments of the present disclosure are not limited thereto, and modifications, variations, and so on thereof can be made.

For example, according to the first embodiment, the first two drops among five drops may be the adjustment drop waveform WB, and the third to fifth drops may be the standard drop waveform WA, but embodiments are not limited thereto.

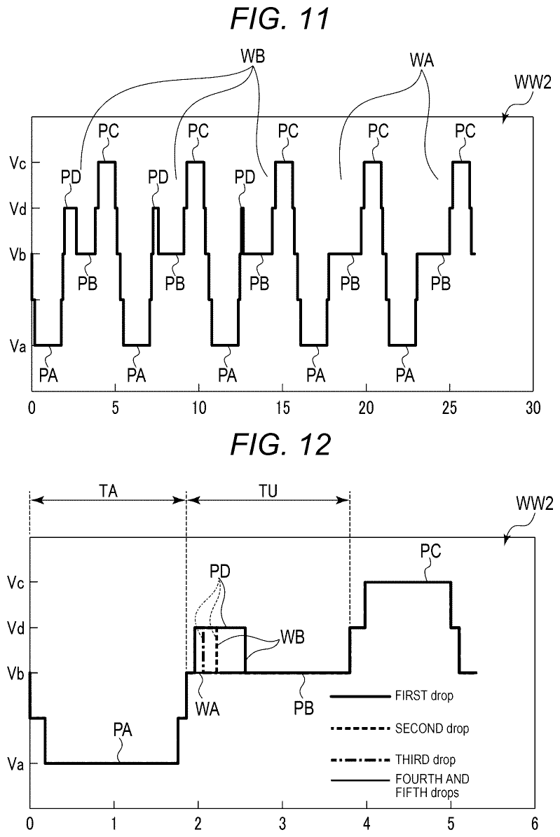

FIG. 11 is a graph illustrating a multidrop waveform according to a second embodiment. FIG. 12 is a waveform diagram illustrating an ejection waveform for each drop. For example, as illustrated in FIGS. 11 and 12, in a multidrop waveform WW2 according to this second embodiment, the first three drops are the adjustment drop waveforms WB, and the fourth and fifth drops are the standard drop waveforms WA.

In the multidrop waveform WW2 according to the second embodiment, the pulse width TD of the auxiliary contraction of the second drop is less than the pulse width TD of the auxiliary contraction of the first drop, and furthermore, the pulse width TD of the auxiliary contraction of the third drop is less than the pulse width TD of the auxiliary contraction of the first drop.

Also in the second embodiment, by adjusting the pulse width TD of the auxiliary contraction element PD, the smaller the contraction amount of the auxiliary contraction the later the drop is in sequence. Also, at least the final drop is a standard drop waveforms WA that does not include the auxiliary contraction element PD. For example, the fourth drop and the fifth drop are standard drop waveforms WA.

In the multidrop waveform WW2, the time TS of each drop is constant, and the pulse width TA of an expansion state is set to AL. In the multidrop waveform WW2, adjustment drop waveforms WB have a total TU of pulse width TD of the auxiliary contraction state and pulse width of the normal state fixed (within a certain range). For example, when reaching the normal state immediately after an expansion element and then reaching the auxiliary contraction state after a certain period of time, that is, when the auxiliary contraction element is inserted at some point in the middle of the normal element, the summed total time in the normal state before and after the auxiliary contraction state may be taken as the pulse width of the normal state in the context.

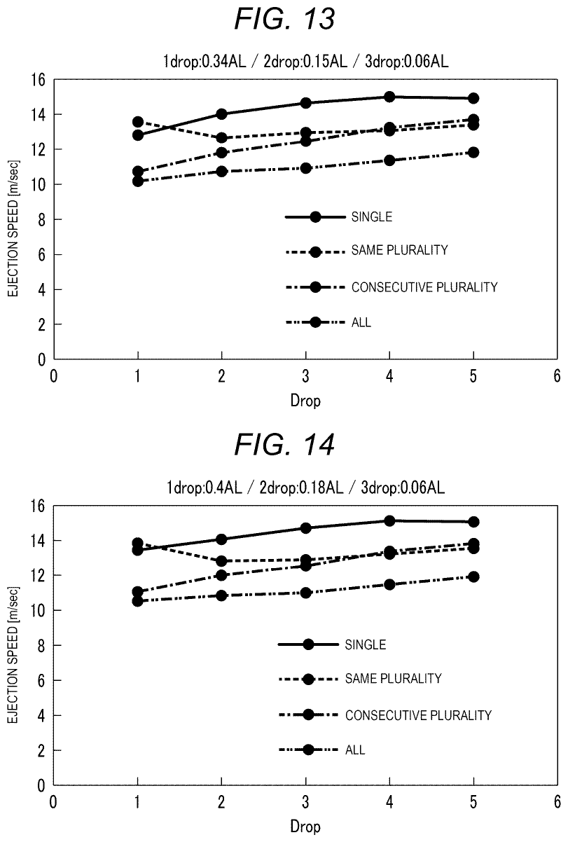

FIGS. 13 to 17 are graphs illustrating measured results of ejection speed when a plurality of nozzles are driven by the multidrop waveform WW2. The horizontal axis represents the drop number in a sequence of drops, and the vertical axis represents ejection speed. Each graph shows ejection speeds for a plurality of different drive conditions (“single,” “plurality,” “consecutive plurality,” “all”) In each case, the output from the same, single nozzle was measured with the differences in conditions being related to which other nozzles are being driven at the same time.

FIG. 13 illustrates a case where the pulse widths TD of the auxiliary contraction elements PD of the first to third drops are respectively 0.34 AL, 0.15 AL, and 0.06 AL.

FIG. 14 illustrates a case where the pulse widths TD of the auxiliary contraction elements PD of the first to third drops are respectively 0.4 AL, 0.18 AL, and 0.06 AL.

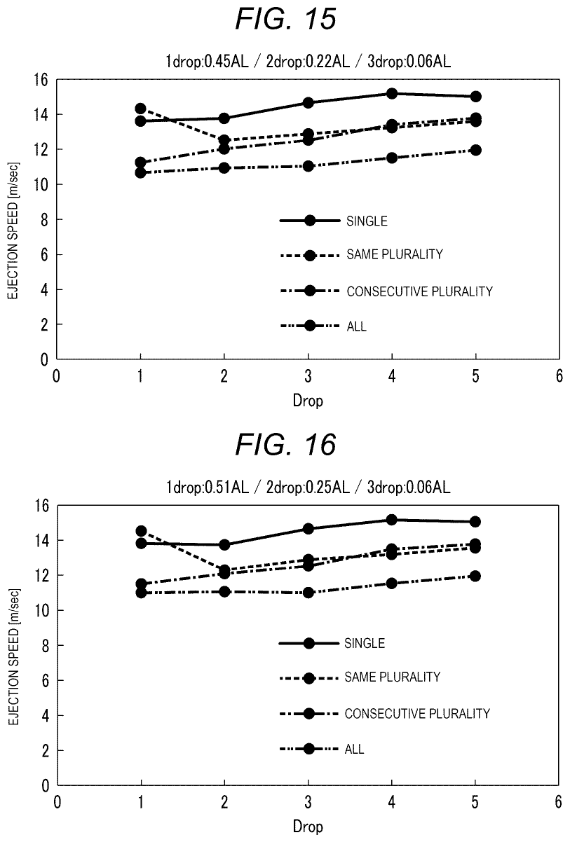

FIG. 15 illustrates a case where the pulse widths TD of the auxiliary contraction elements PD of the first to third drops are respectively 0.45 AL, 0.22 AL, and 0.06 AL.

FIG. 16 illustrates a case where the pulse widths TD of the auxiliary contraction elements PD of the first to third drops are respectively 0.51 AL, 0.25 AL, and 0.06 AL.

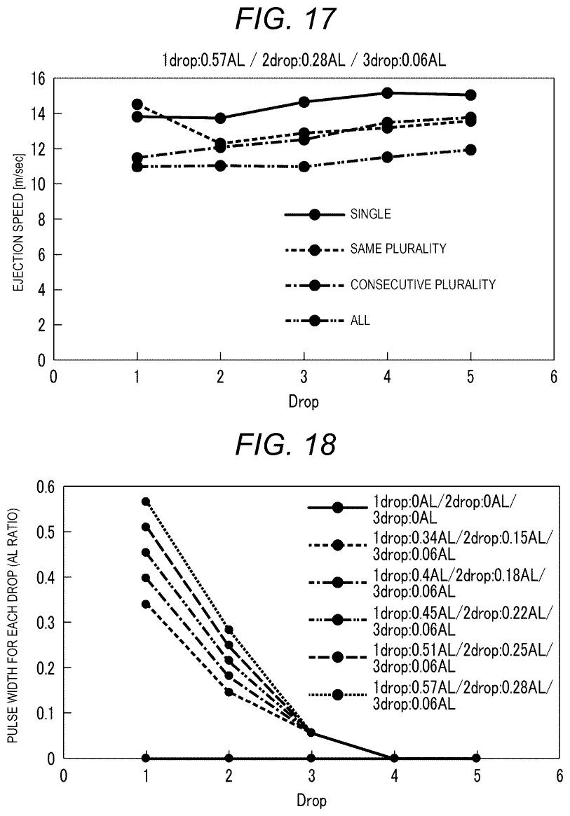

FIG. 17 illustrates a case where the pulse widths TD of the auxiliary contraction elements PD for the first to third drops are respectively 0.57 AL, 0.28 AL, and 0.06 AL.

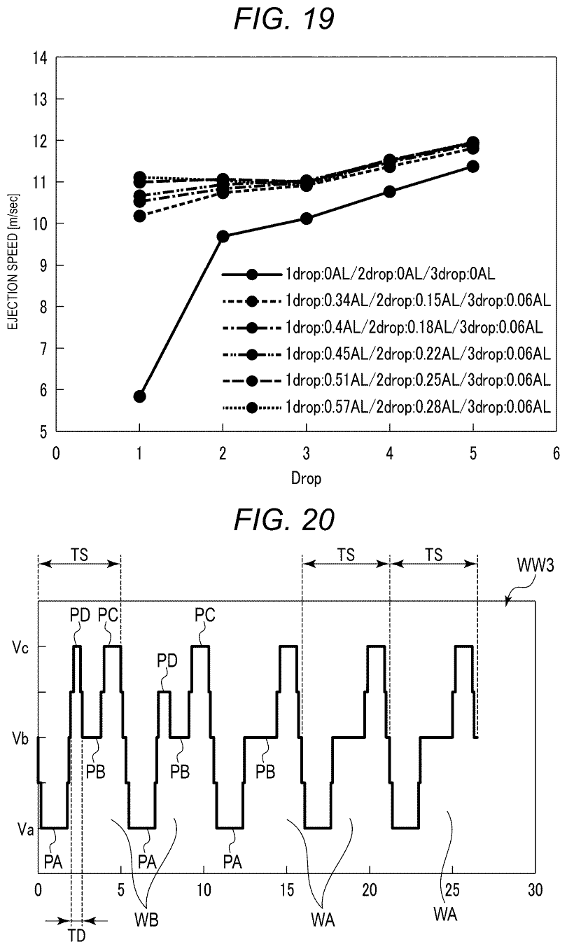

FIG. 18 is a graph illustrating an effect of the pulse width TD of the auxiliary contraction element PD. The horizontal axis represents the drop number in a sequence of drops, and the vertical axis represents the pulse width TD of the auxiliary contraction element PD. FIG. 19 illustrates a comparison between ejection speeds when all nozzles are driven. As illustrated in FIG. 19, it can be seen that, by adjusting the pulse width TD, a difference in ejection speed can be reduced across different drops.

Also in the second embodiment, in the drive waveform for each gradation, the adjustment drop waveforms WB including the auxiliary contraction element PD are with each, and the adjustment is conducted such that the later in the sequence order of drops, the smaller the auxiliary contraction element PD becomes, and thus, a difference in ejection speed can be reduced.

Also, specific conditions of a standard drop waveform and an adjustment drop waveform are not limited to the conditions of the above-described embodiments. For example, the adjustment drop waveform may be any waveform that can adjust an ejection volume, and other conditions can be applied thereto.

An embodiment provides an example of 5-drop drive but the disclosure is not limited thereto, and the number of drops may be 4 or less, or 6 or more. Furthermore, the type of drop waveforms is not limited to two types, and three or four or more types may be combined.

An embodiment provides an example in which the multidrop waveform WW includes a plurality of adjustment drop waveforms WB and a pulse width of the auxiliary contraction element PD of subsequent drops is smaller than the one before, but embodiments are not limited thereto. For example, the number of adjustment drop waveforms WB may be just one. That is, for example, in a two-drop drive, only the first drop need be the adjustment drop waveform WB including the auxiliary contraction element PD, and the second drop may be the standard drop waveform WA. Also, in a case of three or more drops, only the first drop need be the adjustment drop waveform WB, and the second and subsequent drops may be the standard drop waveforms WA.

Also, in some examples, at least some of the drop waveforms in the multidrop waveform may be non-ejection waveforms (e.g., waveforms included for reasons other than specifically to eject a droplet).

Also, although an above-described example provides an example in which ejection speed is adjusted by changes in the pulse width TD of the auxiliary contraction element PD, embodiments are not limited thereto, and it is also possible to change an ejection volume according to a voltage value and a pulse width of another element.

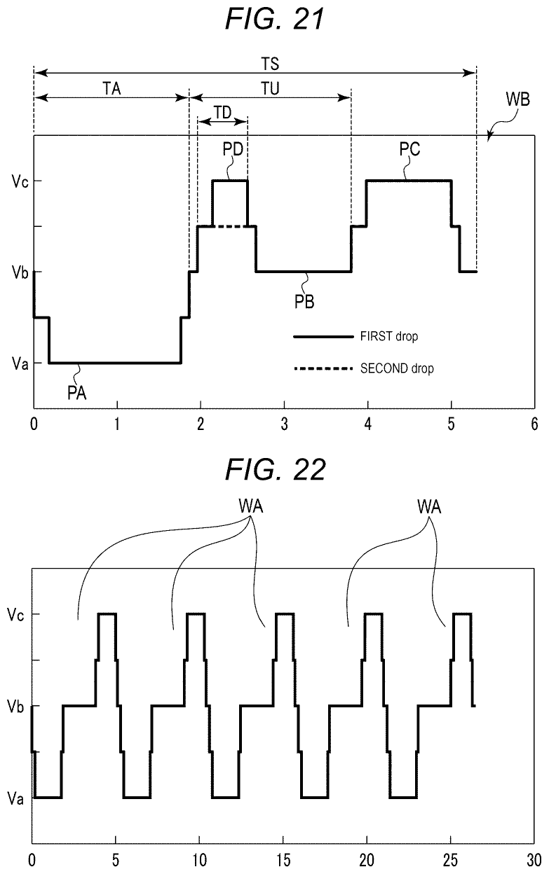

FIG. 20 is a waveform diagram of a multidrop waveform WW3 according to a third embodiment. FIG. 21 is a waveform diagram illustrating an ejection waveform for each drop of the multidrop waveform WW3. As illustrated in FIGS. 20 and 21, in the multidrop waveform WW3, the later the drop, that is, the higher the drop number in the drop sequence, the smaller the amplitude (that is, the voltage value) of the auxiliary contraction pulse of the drop ejection waveform. That is, in the third embodiment, the auxiliary contraction elements PD are different not in width but in height.

For example, in the multidrop waveform WW3, the first and second drops are the adjustment drop waveforms WB, and the third to fifth drops are the standard drop waveforms WA. Here, the auxiliary contraction element PD of the first drop and the auxiliary contraction element PD of the second drop have the same pulse width TD but different voltage values (amplitudes). Specifically, the voltage value of the auxiliary contraction element PD in the first drop is equal to the voltage value of the contraction state, and the voltage value of the auxiliary contraction element PD of the second drop is about half the voltage value of the contraction state. The auxiliary contraction element PD has a smaller pulse width and a smaller contraction amount than the contraction element PC.

Also in the third embodiment, the adjustment drop waveforms WB are combined with each other, and the adjustment is conducted such that the later the drop is in the sequence, the smaller the contraction amount of the auxiliary contraction element PD is, and thus, the difference in ejection speed can be reduced across the drop sequence.

Also, although an above-described embodiment provides an example in which the standard drop waveform WA is applied to at least the final drop, embodiments are not limited thereto. In some examples, all of drop waveforms up to the final drop may be the adjustment drop waveform WB.

Also, a voltage value applied to each piezoelectric element can be adjusted appropriately in response to various conditions. For example, a potential difference may be generated by grounding one of a pair of adjacent piezoelectric elements and applying a voltage to the other, or a potential difference may be generated by applying a voltage to both piezoelectric elements.

A drive waveform is not limited to a pulling waveform but may be a pushing waveform or a push-pulling waveform.

The configuration of the liquid ejection head 1 is not limited to the above-described example, and other types of heads may be used. For example, a liquid ejection head may drive a liquid ejection by using the drive element portion to vibrate a vibration plate provided between a pressure chamber and the drive element portion.

An example in which the liquid ejection device 2 is an inkjet printer that forms a two-dimensional image with ink is described, but the liquid ejection device 2 is not limited thereto, and may be, for example, a 3D printer, an industrial manufacturing machine, or a medical device. The liquid ejection device 2 may be used to form a three-dimensional object by ejecting a material, a binder for solidifying a material, or the like from an inkjet head.

Also, although an embodiment provides an example in which a control operation is performed by the control portion 2118, embodiments are not limited thereto. For example, the liquid ejection head 1 may include a drive circuit for driving an actuator, and the liquid ejection head 1 itself may serve as a drive device or may have a configuration to which a drive device is mounted.

According an embodiment, in the drive waveform, the adjustment drop waveforms WB including the auxiliary contraction elements PD are combined with each other after expansion, and the adjustment is conducted such that the later the drop is in the sequence, the smaller the contraction amount of the auxiliary contraction element PD is, and thus, a difference between ejection speeds of a plurality of drops can be reduced across the drop sequence.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid ejection drive device, comprising:
a drive circuit configured to apply a drive signal to an actuator for driving an ejection of a liquid from a pressure chamber connected to a nozzle, wherein
the drive signal includes a multidrop waveform with a plurality of drop waveforms for causing one droplet to be ejected, each drop waveform having an expansion phase, a normal phase, and a contraction phase, and
at least one drop waveform in the plurality of drop waveforms is an adjustment drop waveform having an auxiliary contraction phase in which contraction of the pressure chamber is less than in the contraction phase, the auxiliary contraction phase after the expansion phase and before the contraction phase.

2. The liquid ejection drive device according to claim 1, wherein the adjustment drop waveform is the first drop waveform in the plurality of drop waveforms of the multidrop waveform.

3. The liquid ejection drive device according to claim 1, wherein
the plurality of drop waveforms includes a plurality of adjustment drop waveforms, and
the plurality of adjustment drop waveforms is before at least one reference drop waveform in the plurality of drop waveforms in the multidrop waveform.

4. The liquid ejection drive device according to claim 1, wherein
the plurality of drop waveforms includes a plurality of adjustment drop waveforms, and
a contraction amount in the auxiliary contraction phase of an adjustment drop waveform later in the multidrop waveform is less than a contraction amount in the auxiliary contraction phase of an adjustment drop waveform earlier in the multidrop waveform.

5. The liquid ejection drive device according to claim 1, wherein a voltage level in the auxiliary contraction phase is higher than a voltage level in the normal phase but lower than or equal to a voltage level in the contraction phase.

6. The liquid ejection drive device according to claim 5, wherein
the plurality of drop waveforms includes a plurality of adjustment drop waveforms, and
a total pulse width of the auxiliary contraction phase and the normal phase in the plurality of adjustment drop waveforms is fixed.

7. The liquid ejection drive device according to claim 1, wherein,
the plurality of drop waveforms includes a plurality of adjustment drop waveforms, and
a total pulse width of the auxiliary contraction phase and the normal phase in the plurality of adjustment drop waveforms is fixed.

8. The liquid ejection drive device according to claim 7, wherein a contraction amount in the auxiliary contraction phase of an adjustment drop waveform later in the multidrop waveform is less than a contraction amount in the auxiliary contraction phase of an adjustment drop waveform earlier in the multidrop waveform.

9. The liquid ejection drive device according to claim 1, wherein
the plurality of drop waveforms includes at least three drop waveforms in sequence,
the first drop waveform in the sequence is the adjustment drop waveform, and
the second and third drop waveforms in the sequence are standard drop waveforms without the auxiliary contraction phase.

10. The liquid ejection drive device according to claim 1, wherein
the plurality of drop waveforms includes a plurality of adjustment drop waveforms, and
a pulse width of the auxiliary contraction phase of an adjustment drop waveform later in the multidrop waveform is less than a pulse width of the auxiliary contraction phase of an adjustment drop waveform earlier in the multidrop waveform.

11. The liquid ejection drive device according to claim 1, wherein
the plurality of drop waveforms includes a plurality of adjustment drop waveforms, and
an amplitude of the auxiliary contraction phase of an adjustment drop waveform later in the multidrop waveform is less than an amplitude of the auxiliary contraction phase of an adjustment drop waveform earlier in the multidrop waveform.

12. A liquid ejection drive device, comprising:
a drive circuit configured to apply a drive signal to an actuator for driving an ejection of a liquid from a pressure chamber connected to a nozzle, wherein
the drive signal is a multidrop waveform with a plurality of drop waveforms for causing one droplet to be ejected, each drop waveform having an expansion phase, a normal phase, and a contraction phase,
at least a first drop waveform in the plurality of drop waveforms is an adjustment drop waveform having an auxiliary contraction phase in which contraction of the pressure chamber is less than in the contraction phase, the auxiliary contraction phase after the expansion phase and before the contraction phase, and
at least a last drop waveform in the plurality of drop waveforms is a standard drop waveform without the auxiliary contraction phase.

13. The liquid ejection drive device according to claim 12, wherein
the plurality of drop waveforms includes a plurality of adjustment drop waveforms in consecutive sequence from the first drop waveform, and
a contraction amount in the auxiliary contraction phase of an adjustment drop waveform later in the multidrop waveform is less than a contraction amount in the auxiliary contraction phase of an adjustment drop waveform earlier in the multidrop waveform.

14. The liquid ejection drive device according to claim 1, wherein a voltage level in the auxiliary contraction phase is higher than a voltage level in the normal phase but lower than or equal to a voltage level in the contraction phase.

15. A liquid ejection device, comprising:
an actuator;
a pressure chamber adjacent to the actuator;
a nozzle connected to the pressure chamber; and
a drive circuit configured to apply a drive signal to the actuator for driving an ejection of a liquid from the pressure chamber, wherein
the drive signal includes a multidrop waveform with a plurality of drop waveforms for causing one droplet to be ejected, each drop waveform having an expansion phase, a normal phase, and a contraction phase, and
at least one drop waveform in the plurality of drop waveforms is an adjustment drop waveform having an auxiliary contraction phase in which contraction of the pressure chamber is less than in the contraction phase, the auxiliary contraction phase after the expansion phase and before the contraction phase.

16. The liquid ejection device according to claim 15, wherein the adjustment drop waveform is the first drop waveform in the plurality of drop waveforms of the multidrop waveform.

17. The liquid ejection device according to claim 15, wherein
the plurality of drop waveforms includes a plurality of adjustment drop waveforms, and
the plurality of adjustment drop waveforms is before at least one reference drop waveform in the plurality of drop waveforms in the multidrop waveform.

18. The liquid ejection device according to claim 15, wherein
the plurality of drop waveforms includes a plurality of adjustment drop waveforms, and
a contraction amount in the auxiliary contraction phase of an adjustment drop waveform later in the multidrop waveform is less than a contraction amount in the auxiliary contraction phase of an adjustment drop waveform earlier in the multidrop waveform.

19. The liquid ejection device according to claim 15, wherein a voltage level in the auxiliary contraction phase is higher than a voltage level in the normal phase but lower than or equal to a voltage level in the contraction phase.

20. The liquid ejection device according to claim 15, wherein,
the plurality of drop waveforms includes a plurality of adjustment drop waveforms, and
a total pulse width of the auxiliary contraction phase and the normal phase in the plurality of adjustment drop waveforms is fixed.
